(19) United States
(12) Patent Application Publication
(10) Pub. No.: US 2025/0205698 A1
(43) Pub. Date: Jun. 26, 2025

(54) METHOD FOR DOSING A LIQUID QUANTITY AND PIPETTE FOR DOSING A LIQUID QUANTITY

(71) Applicant: Festo SE & Co. KG, Esslingen (DE)

(72) Inventor: Martin BOCHTERLE, Fellbach (DE)

(21) Appl. No.: 18/978,695

(22) Filed: Dec. 12, 2024

(30) Foreign Application Priority Data
Dec. 20, 2023 (DE) 102023135959.2

(51) Int. Cl. B01L 3/02

(52) U.S. Cl. CPC B01L 3/021; B01L 2200/026; B01L 2200/146; B01L 2400/0478

(57) ABSTRACT

A method for dosing a liquid quantity, including the steps of: moving a working fluid in a fluid channel of a pipetting tip support, which fluid channel extends at least from a first fluid channel limit to a second fluid channel limit, detecting a fluid movement taking place over the first fluid channel limit and/or the second fluid channel limit with a sensor arrangement associated with the fluid channel, which sensor arrangement includes a first pressure sensor and a further sensor from the group: second pressure sensor, position sensor.

This application claims priority to DE 10 2023 135 959.2, filed 20 Dec. 2023, which is incorporated herein by reference.

### BACKGROUND OF THE INVENTION

The invention relates to a method for dosing a liquid quantity and a pipette for dosing a liquid quantity.

Pipettes known from the prior art for dosing a liquid quantity comprise, for example, a pressure chamber, a pipetting tip support which can be coupled to a pipetting tip, a working valve apparatus associated with the pressure chamber, an outlet valve positioned between the pressure chamber and the pipetting tip support and a fluid channel positioned in the pipetting tip support. In methods for dosing a liquid quantity known from the prior art, a pressure is initially provided in the pressure chamber which pressure is lower than the pressure in the fluid channel. Furthermore, a pipetting tip is coupled to the pipetting tip support. The pipetting tip is then immersed in a sample fluid and the outlet valve is opened. The negative pressure in the pressure chamber results in a suction effect, due to which a working fluid held in the fluid channel is sucked towards the pressure chamber. This in turn results in a suction effect in the pipetting tip, whereby sample fluid is sucked into the pipetting tip and thus taken up into the pipetting tip. The outlet valve is then closed again, which interrupts the suction effect in the pipetting tip and no further sample fluid is sucked into the pipetting tip. From this moment on, a certain amount of sample fluid, preferably the desired amount of sample fluid, is in the pipetting tip. At a given time and at a desired position, the sample fluid taken up in the pipetting tip is then dispensed again. For this purpose, overpressure is provided in the pressure chamber and the outlet valve is opened.

Pipettes with external fluid source are also known, in which fluid movement in the pipette is caused by providing a negative or positive pressure with the fluid source. Piston pipettes in which fluid is moved with a piston are also known.

### SUMMARY OF THE INVENTION

The object of the present invention is to provide a method for dosing a liquid quantity and a pipette for dosing a liquid quantity, which have a high dosing accuracy when performing the dosing operation.

This object is solved by a method for dosing a liquid quantity comprising the steps set out below:

Moving a working fluid in a fluid channel of a pipetting tip support, which fluid channel extends at least from a first fluid channel limit to a second fluid channel limit, detecting a fluid movement taking place over the first fluid channel limit and/or the second fluid channel limit with a sensor arrangement associated with the fluid channel, which sensor arrangement comprises a first pressure sensor and a further sensor from the group: second pressure sensor, position sensor.

The fluid movement can be caused by a fluid flowing into the fluid channel and/or a fluid flowing out of the fluid channel. Preferably, the fluid movement is determined in relation to a reference cross-section or a reference volume of the fluid channel. If a mass flow rate is determined in relation to a reference cross-section or a reference volume of the fluid channel, this mass flow rate can be determined along two opposing directions. If the same flow is mapped, the amounts of a mass flow rate related to this flow along a first direction through a reference cross-section and a mass flow rate related to this flow in a second direction opposite to the first direction through the same reference cross-section are identical. However, the respective values have different signs. If a mass flow rate is determined along a direction pointing to a reference volume in relation to this reference volume, a positive sign of the value associated with the mass flow rate indicates an inflow into the reference volume and a negative sign indicates an outflow from the reference volume.

If, in the following, a flow direction is specified in relation to a reference cross-section, e.g. the first fluid channel limit, in relation to a reference volume, e.g. into the fluid channel, this means that if fluid flows into the fluid channel accordingly, the associated flow characteristic value has a positive sign and if fluid flows out of the fluid channel accordingly, the associated flow characteristic value has a negative sign. If reference is made in the following to a flow direction in relation to a reference volume, the correspondingly discussed value includes both those characteristic values which have a positive sign, i.e., in which the flow actually runs along the flow direction under consideration, and those characteristic values which have a negative sign, i.e., in which the flow runs in the opposite direction to the flow direction under consideration.

Dosing is understood to be the suction of a desired amount of sample fluid into a pipetting tip of the pipette coupled to the pipetting tip support and the dispensing of a possibly different desired amount of sample fluid from the pipetting tip.

For this purpose, in a first step, a negative pressure is generated in the fluid channel, or a negative pressure is provided to the fluid channel by a separately formed negative pressure source, such as a negative pressure pump. The pressure present in the fluid channel is also referred to as the first pressure and is lower than an ambient pressure in an area surrounding the pipette when the fluid channel is pressurized.

The ambient pressure can typically be assumed to be normal pressure (1,013 mbar), but can also be higher or lower, for example when using the pipette in a safety area of a laboratory with a slightly negative pressure. The pipette will then be immersed in a sample fluid or is already immersed in the sample fluid. Sample fluid is then sucked into the fluid channel by the negative pressure in the fluid channel.

In a further step, a desired amount of sample fluid is dispensed from the pipetting tip at a desired position after pressurizing the fluid channel, for example into a sample container provided for this purpose.

If the exact geometries and pressures of the pipette components to which the working fluid and/or sample fluid is applied were known, the volume of sample fluid held and/or dispensed could be concluded. However, these pressures, especially with regard to the pipetting tip, can only be determined precisely with great effort and thus not economically, since in operation, especially with critical sample fluids, the pipetting tips are disposed of after a small number of applications, e.g., after a single use.

In order to be able to increase the dosing accuracy, it is intended according to the invention to determine at least one characteristic value from the group: change of the amount of the working fluid in the fluid channel, pipetting tip pressure in a pipetting tip coupled to the pipetting tip support, volume flow of a sample fluid flowing into a pipetting tip coupled to the pipetting tip support, viscosity of a sample fluid flowing into a pipetting tip coupled to the pipetting tip support, volume of a sample fluid held in a pipetting tip coupled to the pipetting tip support with a sensor signal of the first pressure sensor and a sensor signal of the further sensor.

The aforementioned characteristic values to be determined are also referred to as characteristic values of so-called soft sensors. This term is used to express the fact that the characteristic values to be determined can be determined by means of corresponding real, i.e., physically existing, sensors without such a real sensor having to be provided at the position in question. For this purpose, other real sensors must be provided elsewhere, whereby the characteristic values associated with the respective soft sensors are determined on the basis of the characteristic values determined with these real sensors. Preferably, the soft sensors are associated with positions where a sensor cannot be used economically, in particular in the pipetting tip or soft sensors of such a type that would be too expensive or take up too much installation space if provided as real sensors.

Preferably, when determining the aforementioned characteristic values, effects that are related to the immersion of the pipetting tip in a fluid to be dosed are disregarded due to their minor influence. Such effects are, for example, capillary effects occurring in relation to the pipetting tip and the hydrostatic pressure of a liquid sample fluid, which depends on the depth at which the pipetting tip is immersed. For example, an immersion of the pipetting tip of one centimeter into a sample fluid at normal ambient pressure (1,013 mbar) only leads to a pressure deviation of 1 mbar, i.e., a deviation of only approx. 0.1%.

The method according to the invention can be carried out during the aspiration of sample fluid into a pipette and/or during the dispensing of sample fluid from the pipette.

Preferably, the pipetting tip is configured in such a way that the amount of sample fluid to be received in the pipette can be completely taken up in the pipetting tip. This prevents the sample fluid from coming into contact with the fluid channel. This ultimately prevents the pipetting tip support from having to be cleaned after dosing. Common internal volumes of pipetting tips range from 10 microliters to 2,000 microliters and in particular from 20 microliters to 1,000 microliters. Common internal volumes of the fluid channel extending from the first fluid channel limit to the second fluid channel limit or of the section of the fluid channel extending from the first fluid channel limit to the second fluid channel limit range from 100 microliters to 1,000 microliters, preferably from 150 microliters to 800 microliters, particularly preferably from 250 to 450 microliters.

The change of the amount of substance is preferably to be understood as a mass flow, a volume flow or a stream of a transformed amount of substance, i.e., the derivative of the mass, the volume or the transformed amount of substance after time, or a mass or volume difference or a difference of the transformed amount of substance in each case with respect to a fixed reference cross-section or a fixed reference volume. The transformed amount of substance is to be understood as the product of the amount of substance, a molar gas constant and a temperature according to the following formula, where n_{RT} is the transformed amount of substance, n is the amount of substance, Rₘ is the molar gas constant and T is the temperature:

n_{RT}=n·Rₘ·T

If reference is made in the following to quantities of substances or flows of quantities of substances, transformed quantities of substances or flows of transformed quantities of substances are preferably meant.

If the density of the corresponding fluid is known, the mass flow and the volume flow can be converted into each other. The same applies if the molar mass and the molar volume are known for converting the mass into a quantity of substance, the volume into the quantity of substance and vice versa.

In this method of dosing a liquid quantity, an isothermal process is assumed. Therefore, the equation of state of ideal gases can be used in the following simplified form, wherein ρ is a pressure and V is a volume:

ρ·V=n_{RT}

A gas is preferably used as the working fluid, in particular air, and a liquid is preferably used as the sample fluid. This prevents the working fluid from mixing with the sample fluid, as could occur, for example, if a liquid is used as the working fluid. Air is a particularly cost-effective working fluid.

The fluid channel is associated with an internal volume that extends from a first fluid channel limit to a second fluid channel limit. The first fluid channel limit is located in the immediate vicinity of the first pressure sensor, with the first pressure sensor being associated with the aforementioned internal volume. The second fluid channel limit is positioned opposite the first fluid channel limit at the end of the fluid channel at which the pipetting tip is coupled to the pipetting tip support.

Preferably, the further sensor is configured as a second pressure sensor, which is associated with a pressure chamber fluidically connected to the fluid channel, wherein a second pressure in the pressure chamber is determined with the second pressure sensor, wherein the working fluid is moved in the fluid channel by opening an outlet valve positioned between the pressure chamber and the fluid channel in order to at least partially equalize a pressure difference between the pressure chamber and the fluid channel. A pipette for carrying out such a method is also referred to below as a pressure chamber pipette. In the aforementioned case, the first fluid channel limit is positioned between the outlet valve and the first pressure sensor.

When the outlet valve is closed, the second pressure is lower than the first pressure in the fluid channel. The outlet valve is then opened, causing a pressure drop in the fluid channel due to the equalization of the first pressure and the second pressure. This pressure drop allows sample fluid to be taken up into a pipetting tip, provided that the pipetting tip is coupled to the pipetting tip support and the pipetting tip is immersed in the sample fluid.

In a further step, a desired amount of sample fluid is released from the pipetting tip at a desired position, for example into a sample container provided for this purpose, after the outlet valve has been closed in the meantime and the pressure chamber has been pressurized and the outlet valve has then been opened, causing an overpressure to form in the fluid channel.

The outlet valve can be moved from a closed position, in which no fluid can pass through the outlet valve, to an open position, in which fluid can pass through the outlet valve, and from the open position to the closed position. As explained above, the intake of the sample fluid into the pipette is initiated when the outlet valve is opened. After the desired amount of sample fluid has flowed into the pipette, the outlet valve is moved back to the closed position, whereby the pressure difference causing the fluid flow no longer exists and no further sample fluid flows into the pipette.

The outlet valve can be configured as a simple switching valve, which can only be switched between the open position and the closed position, or as a more complex proportional valve, which can also be switched to intermediate positions between the open position and the closed position.

Alternatively, the further sensor is configured as a second pressure sensor, wherein the sensor arrangement is used to determine a flow rate through an inlet valve positioned on the fluid channel, wherein the working fluid is moved in the fluid channel by opening the inlet valve in order to at least partially equalize a pressure difference between a fluid source fluidically connected to the fluid channel. A pipette for carrying out such a method is also referred to below as a pipette with external fluid source. In the aforementioned case, the first fluid channel limit is positioned between the first pressure sensor and the second pressure sensor.

The fluid source can act as a pressure source so that working fluid can be introduced from the pressure source into the fluid channel, in particular to discharge sample fluid from the pipetting tip.

The fluid source can also act as a vacuum source so that working fluid can be discharged from the fluid channel in the direction of the vacuum source, in particular to introduce sample fluid into the pipetting tip.

Preferably, a throttle is positioned between the first pressure sensor and the second pressure sensor. The flow rate through the inlet valve can then be determined according to the International Standard ISO 6358-1, First edition 2013-05-15: Pneumatic fluid power—Determination of flow-rate characteristics of components using compressible fluids—Part 1: General rules and test methods for steady-state flow (hereinafter referred to as “ISO 6358-1:2013(E)”) using the differential pressure method. It is not the actual flow through the inlet valve that is measured, but the flow through the sensor arrangement. If the sensor arrangement is positioned near the inlet valve and no fluid outlets are provided between the sensor arrangement and the inlet valve, the flow rate determined with the sensor arrangement corresponds at least approximately to the actual flow rate through the inlet valve.

Alternatively, the further sensor is configured as a position sensor, with which a travel path of a piston positioned in the fluid channel is determined, wherein the working fluid is moved in the fluid channel by moving the piston along the fluid channel. A pipette for carrying out such a method is also referred to below as a piston pipette. In the aforementioned case, the first fluid channel limit is positioned directly in front of the first pressure sensor when viewed from the direction of the piston. The piston cannot pass the first fluid channel limit in any position; at most, the piston can touch the first fluid channel limit. The piston pipette also has a third fluid channel limit which is positioned opposite the first fluid channel limit in the vicinity of the end of the fluid channel which is opposite the end of the fluid channel at which the pipetting tip is coupled to the pipetting tip support. The piston is movable between the third fluid channel limit and the first fluid channel limit. In the position in which the piston is maximally extended out of the fluid channel, i.e., in the position in which a maximum internal volume of the fluid channel is limited by the piston, a side of the piston facing the first pressure sensor is at the level of the third fluid channel limit. In the position in which the piston is maximally retracted, i.e., in the position in which a minimum internal volume of the fluid channel is limited by the piston, the side of the piston facing the first pressure sensor is at the level of the first fluid channel limit.

If the piston is moved away from the position at which the pipetting tip is coupled to the pipetting tip support, the working fluid in the fluid channel expands, so that either further working fluid flows into the fluid channel via the aforementioned position or, if a pipetting tip is coupled to the pipetting tip support, sample fluid flows in the direction of the fluid channel and is thus picked up in the pipetting tip. If the piston is moved in the direction of the aforementioned position, the working fluid held in the fluid channel is also moved in the direction of the aforementioned position by being pushed in this direction by the piston.

As a result, if sample fluid is held in the pipetting tip and the working fluid builds up sufficient pressure, i.e., the piston is moved sufficiently far, the sample fluid is at least partially discharged from the pipette. If there is no sample fluid in the pipetting tip, the working fluid is discharged from the pipette according to the distance traveled by the piston.

The piston can be operated manually so that dosing is done manually. The piston can also be powered by an energy source, in particular electrically. An electrically operated linear motor or pinion motor can be provided as a drive for this purpose.

The three alternatives described above, i.e., the pressure chamber pipette, the pipette with external fluid source and the piston pipette, are each configured in the same way, at least between the first fluid channel limit and the second fluid channel limit. When reference is made in the following to the fluid channel, this refers to the fluid channel or the section of the fluid channel extending from the first fluid channel limit to the second fluid channel limit.

A mass flow of the working fluid into the pipetting tip via the second fluid channel limit, i.e., an inflow into the pipetting tip, corresponds to a mass flow of the working fluid out of the fluid channel via the second fluid channel limit, i.e., an outflow from the fluid channel.

Preferably, a mass flow rate of the working fluid across the second fluid channel limit into a pipetting tip is determined as a difference between a mass flow rate of the working fluid across the first fluid channel limit into the fluid channel and a change of the amount of the working fluid in the fluid channel. The aforementioned mass flow of the working fluid into the fluid channel is directed towards the second fluid channel limit.

Preferably, the mass flow rate of the working fluid across the second fluid channel limit into the pipetting tip \dot{n}_{inflow,pipetting tip} is determined according to the following formula, where \dot{n}_{inflow,fluid channel} is the mass flow rate of the working fluid across the first fluid channel limit into the fluid channel and \dot{n}_{fluid channel} is the change of the amount of the working fluid in the fluid channel:

$${\dot{n}}_{inflow , pipetting tip} = {\dot{n}}_{inflow , fluid channel} - {\dot{n}}_{fluid channel}$$

In the above and also in the following formula symbols, the term inflow refers only to the direction of flow under consideration but does not exclude values with a negative sign that correspond in reality to an outflow (see above).

Preferably, the change of the amount of the working fluid in the fluid channel is determined as a product of the derivative of the first pressure after time and a fluid channel volume of the fluid channel. The fluid channel volume is the internal volume of the fluid channel. The fluid channel volume can be determined using a pressure pulse method or an optical method, for example.

Preferably, the change of the amount of the working fluid in the fluid channel \dot{n}_{fluid channel} is determined according to the following formula, where \dot{p}₁ is the derivative of the first pressure with respect to time and V_{fluid channel} is the fluid channel volume:

\dot{n}_{fluid channel}=\dot{p}₁·V_{fluid channel}

Preferably, with respect to pressure chamber pipettes the mass flow rate of the working fluid across the first fluid channel limit into the fluid channel is determined as a product of the derivative of the second pressure after time and a pressure chamber volume of the pressure chamber. The internal volume of the pressure chamber is referred to as the pressure chamber volume. The pressure chamber volume can be determined, for example, using a pressure pulse method or an optical method. The mass flow rate of the working fluid across the first fluid channel limit into the fluid channel corresponds to the equivalent of the change of the amount of the working fluid held in the pressure chamber in pressure chamber pipettes. Accordingly, the amount of the amount of the working fluid flowing across the first fluid channel limit into the fluid channel corresponds to the amount of the change of the amount of the working fluid held in the pressure chamber, while the signs of the two aforementioned characteristic values are different.

Preferably, with respect to pressure chamber pipettes, the mass flow rate of the working fluid across the first fluid channel limit into the fluid channel \dot{n}_{inflow,fluid channel} is calculated according to the following formula, where \dot{p}₂ is the derivative of the second pressure with respect to time and V_{pressure chamber} is the pressure chamber volume:

$${\dot{n}}_{inflow , fluid channel} = - {\dot{p}}_{2} \cdot {V}_{p r e ssure chamber}$$

Preferably, with respect to pipettes with external fluid source the mass flow rate of the working fluid across the first fluid channel limit into the fluid channel is determined on the basis of the first pressure and a second pressure determined with the second pressure sensor according to ISO 6358-1:2013(E). Particularly preferably, the determination of the mass flow rate of the working fluid via the first fluid channel limit into the fluid channel is additionally carried out on the basis of flow parameters of the fluid channel. These flow characteristics of the fluid channel are, in particular, its sonic conductance, its critical pressure ratio, its subsonic index and its cracking pressure. Furthermore, these flow characteristics are preferably used or determined in relation to the throttle.

Preferably, with respect to piston pipettes the mass flow rate of the working fluid across the first fluid channel limit into the fluid channel is determined as a derivative of the product of the first pressure and a piston channel volume of the fluid channel extending from the first fluid channel limit to the third fluid channel limit after time. The piston channel volume corresponds to the internal volume of the section of the fluid channel in which the piston can move.

Preferably, in the case of piston pipettes, the mass flow of the working fluid across the first fluid channel limit into the fluid channel n_{inflow,fluid channel} is determined according to the following formula, where V_{piston channel} is the piston channel volume:

$${\dot{n}}_{inflow , fluid channel} = - ( {p}_{1} \cdot \dot{{V}_{piston channel}} )$$

Preferably, a pipetting tip pressure in a pipetting tip coupled to the pipetting tip support is determined as the difference between the first pressure and a first differential pressure.

Preferably, the pipetting tip pressure ρ_{pipetting tip} is determined according to the following formula, where ρ₁ is the first pressure and Δρ₁ is the first differential pressure:

$${p}_{pipetting tip} = {p}_{1} - Δ {p}_{1}$$

Preferably, the first differential pressure is determined as the product of a flow resistance counteracting the working fluid and the mass flow rate of the working fluid across the second fluid channel limit into a pipetting tip.

Preferably, the first differential pressure Δρ₁ is determined according to the following formula, where F_{w,working fluid} is the flow resistance of the working fluid:

Δρ₁=F_{w,working fluid}·\dot{n}_{inflow,pipetting tip}

According to a preferred alternative, the first differential pressure is determined from flow characteristics of the fluid channel and the mass flow of the working fluid across the second fluid channel limit into the pipetting tip according to ISO 6358-1:2013(E).

Preferably, an ambient pressure in an environment is determined by means of an ambient pressure sensor associated with the environment, wherein the environment surrounds a pipetting tip coupled to the pipetting tip support, wherein a second differential pressure is determined as the difference between the pipetting tip pressure and the ambient pressure.

Preferably, the second differential pressure Δρ₂ is determined according to the following formula, where ρ_{ambiance} is the ambient pressure:

$$Δ {p}_{2} = {p}_{pipetting tip} - {p}_{a m b i a n c e}$$

Preferably, a flow resistance of the sample fluid is determined as the quotient of the second differential pressure as the divisor and a derivative of a sample volume taken up in a pipetting tip coupled to the pipetting tip support after time as the divisor.

Preferably, the flow resistance of the sample fluid F_{w,sample fluid} is determined according to the following formula, where Vₛₐₘₚₗₑ is the derivative of the sample volume after time:

$${F}_{w , sample fluid} = \frac{Δ {p}_{2}}{{\dot{V}}_{s a m p l e}}$$

Preferably, the sample volume is determined as the difference between a pipetting tip volume of the pipetting tip and a working fluid volume present in the pipetting tip.

Preferably, the sample volume Vₛₐₘₚₗₑ is determined according to the following formula, where V_{pipetting tip} is the pipetting tip volume and V_{working fluid} is the working fluid volume in the pipetting tip:

$${V}_{s a m p l e} = {V}_{pipetting tip} - {V}_{working fluid}$$

The pipetting tip volume is the internal volume of the pipetting tip, in particular in the state in which the pipetting tip is coupled to the pipetting tip support. Preferably, the pipetting tip volume V_{Pipettierspitze} is determined by means of a pressure pulse method or by means of an optical method. Alternatively, the pipetting tip volume can be derived from design or manufacturing files, e.g., from CAD data.

Preferably, the working fluid volume present in the pipetting tip is determined by means of a working fluid amount contained in the pipetting tip, wherein the working fluid amount contained in the pipetting tip is determined as the difference between a working fluid amount initially contained in the pipetting tip and a working fluid amount transferred from the pipetting tip into the fluid channel via the second fluid channel limit. The amount of working fluid initially contained in the pipetting tip is the amount of working fluid contained in the pipetting tip immediately before the working fluid is moved in the fluid channel.

Preferably, the amount of working fluid introduced into the fluid channel by the pipetting tip via the second fluid channel limit is determined as the integral of the change of the amount of the working fluid in the pipetting tip over time.

Preferably, the amount of working fluid n_{working fluid,meas} contained in the pipetting tip at a time tₘₑₐₛ is determined according to the following formula, where t is the time, t₀ is the time at the beginning of the measurement, tₘₑₐₛ is the time at the end of the measurement and n_{working fluid,0} is the initial amount of working fluid contained in the pipetting tip:

$${n}_{w o rking fluid , m e a s} = {n}_{w o rking fluid , 0} - {\int }_{{c}_{0}}^{{t}_{m e a s}} {\dot{n}}_{pipetting tip} dt$$

The amount of working fluid n_{working fluid,meas} contained in the pipetting tip at the time tₘₑₐₛ can also be determined at other times and is referred to below as the amount of working fluid n_{working fluid} present in the pipetting tip.

Preferably, the working fluid volume in the pipetting tip is determined as the quotient of the working fluid volume present in the pipetting tip as the dividend and the pipetting tip pressure as the divisor.

Preferably, the working fluid volume in the pipetting tip V_{working fluid} is determined according to the following formula:

$${V}_{Working fluid} = \frac{{n}_{w orking fliud}}{{p}_{pipetting tip}}$$

Preferably, the initial amount of working fluid contained in the pipetting tip is determined as the product of an initial pipetting tip pressure and the pipetting tip volume.

Preferably, the initial amount of working fluid n_{working fluid,0} contained in the pipetting tip is determined according to the following formula, where ρ_{pipetting tip,0} is the initial pipetting tip pressure:

n_{working fluid,0}=ρ_{pipetting tip,0}·V_{pipetting tip}

Preferably, the flow resistance of the sample fluid is used to determine the viscosity of the sample fluid. Thus, it can be checked whether the determined, i.e., the actual viscosity corresponds to the expected viscosity, which can improve process reliability. If, for example, only air is sucked in instead of a sample fluid or a mixture of the sample fluid and air instead of the pure sample fluid, a viscosity is determined that is lower than the expected viscosity. A corresponding error warning can then be issued, for example. Determining the viscosity also makes it possible to monitor fluids with changing viscosity, for example to determine the coagulation of blood or the curing condition of paints or similar.

The flow resistance of the sample fluid depends on the viscosity of the sample fluid, the density of the sample fluid and the dosing speed. The dosing speed can be set as a process parameter or determined as a characteristic value using known process parameters. If a liquid is used as the sample fluid, an incompressible fluid can preferably be assumed at least approximately. Accordingly, the density of the sample fluid can be assumed to be at least approximately constant. Thus, if the flow resistance of the sample fluid is known, the viscosity of the sample fluid can be determined with the aid of a viscosity term. Preferably, there is at least an approximately linear relationship between the flow resistance of the sample fluid and the viscosity of the sample fluid. Accordingly, a viscosity constant can be used as the viscosity term.

Preferably, the viscosity of the sample fluid η_{sample fluid} is determined according to the following formula, where k_{viscosity} corresponds to the viscosity constant:

η_{sample fluid}=F_{w,sample fluid}−k_{viscosity},

The object is further solved by a pipette for dosing a liquid quantity with the features listed below:

A pipette for dosing a liquid quantity according to the invention comprises a pipetting tip support, a fluid channel associated to the pipetting tip support, a sensor arrangement which is associated to the fluid channel and comprises a first pressure sensor and a further sensor from the group: second pressure sensor, position sensor, and a processing apparatus which is set up to retrieve signals from the sensor arrangement, wherein the fluid channel extends from a first fluid channel limit to a second fluid channel limit, characterized in that the processing apparatus is configured to determine at least one characteristic value from the group: change of the amount of the working fluid in the fluid channel, pipetting tip pressure in a pipetting tip coupled to the pipetting tip support, volume flow of a sample fluid flowing into a pipetting tip coupled to the pipetting tip support, viscosity of a sample fluid flowing into a pipetting tip coupled to the pipetting tip support, volume of a sample fluid held in a pipetting tip coupled to the pipetting tip support with a sensor signal of the first pressure sensor and a sensor signal of the further sensor.

Preferably, a pressure chamber fluidically connected to the fluid channel is provided, the further sensor being configured as a second pressure sensor and being associated with the pressure chamber, wherein a working valve apparatus associated with the pressure chamber and an outlet valve positioned between the pressure chamber and the fluid channel are provided, wherein preferably the processing apparatus is configured to control the working valve apparatus and/or the outlet valve.

The working valve apparatus can, for example, be configured as a single valve or comprise an inlet and an outlet valve. This valve or this inlet and outlet valve can be configured as a simple switching valve or as a proportional valve (see above). The working valve apparatus is configured to ventilate and exhaust the pressure chamber, whereby, if an inlet valve and an outlet valve are provided, the pressure chamber is ventilated by means of the inlet valve and exhausted by means of the outlet valve.

Alternatively, the second sensor is configured as a second pressure sensor, wherein a throttle is positioned between the first pressure sensor and the second pressure sensor, wherein an inlet valve is positioned on the fluid channel, wherein the sensor arrangement is configured to determine a flow rate through the inlet valve, wherein preferably the processing apparatus is configured to control the inlet valve.

The throttle is positioned in the fluid channel and acts as a local constriction of the cross-section of the fluid channel.

Alternatively, a piston is positioned in the fluid channel, the further sensor being configured as a position sensor, with which a travel path of the piston along the fluid channel can be determined, the processing apparatus preferably being configured to control the piston.

Preferably, the pipette according to the invention can be used several times, the pipetting tip support being configured for coupling with a pipetting tip which can be easily disposed of after a small number of uses, e.g., after a single use.

### BRIEF DESCRIPTION OF THE DRAWINGS

The invention is explained in more detail below with reference to the enclosed drawing. It shows

FIG. 1A a pipette for dosing a liquid quantity,

FIG. 1B another pipette for dosing a liquid quantity,

FIG. 1C another pipette for dosing a liquid quantity,

FIG. 2 the pipette shown in FIG. 1A with a pipetting tip coupled to a pipetting tip support,

FIG. 3 a detail of the pipette shown in FIG. 2 with little sample fluid taken up in the pipetting tip,

FIG. 4 the detail shown in FIG. 3 with a lot of sample fluid taken up in the pipetting tip, and

FIG. 5 a method for dosing a liquid quantity.

### DETAILED DESCRIPTION

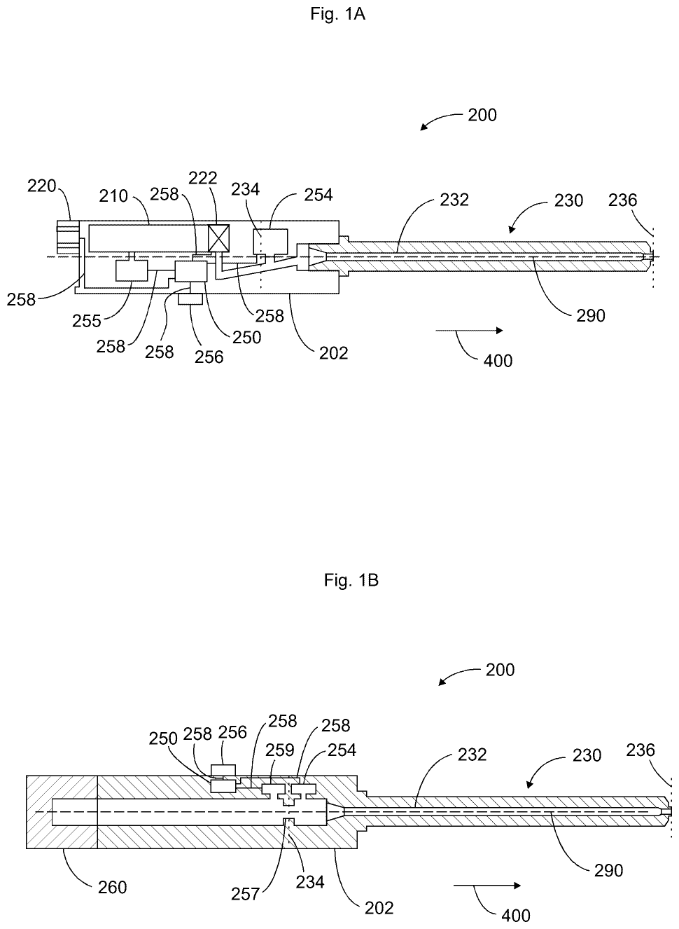

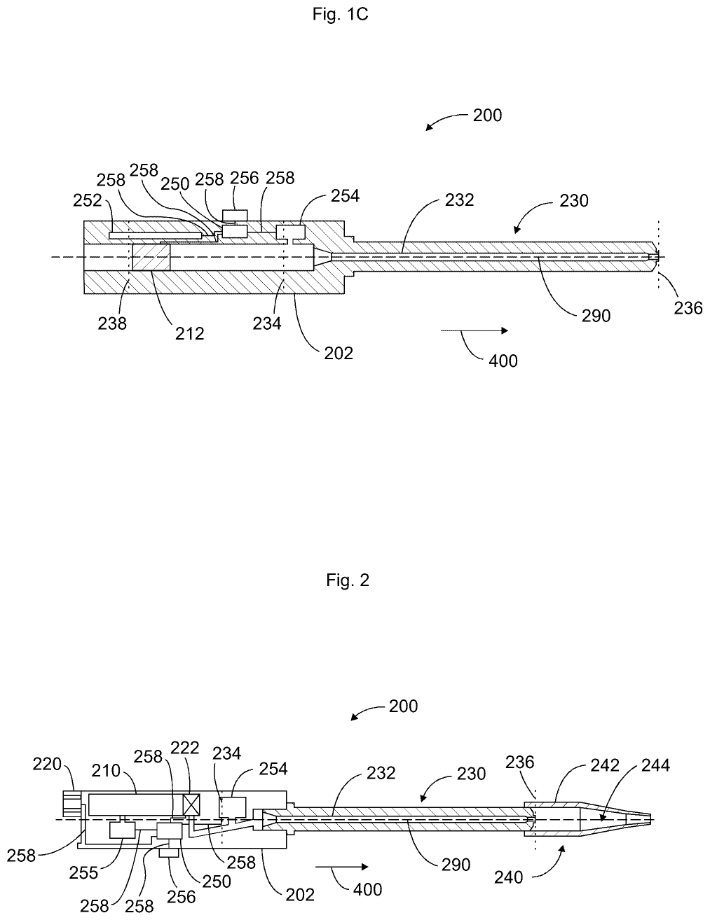

FIG. 1A shows a pipette 200 for dosing a liquid quantity. The pipette 200 has a pressure chamber 210. The pipette 200 preferably further comprises a main body 202 in which the pressure chamber 210 is positioned. The pipette 200 further comprises a first pressure sensor 254 associated with the fluid channel 232. The first pressure sensor 254 is configured to provide a signal dependent on a pressure in the fluid channel 232, which is referred to as the first pressure. By way of example only, the first pressure sensor 254 is positioned in the main body 202. The pipette 200 further comprises a working valve apparatus 220 associated with the pressure chamber 210. Purely by way of example, the working valve apparatus 220 is positioned on the main body 202. The pipette 200 further comprises a processing apparatus 250, which is positioned purely by way of example in the main body 202. The processing apparatus 250 can also be positioned outside the pipette 200, for example in an external, in particular mobile, terminal device. If the processing apparatus 250 is positioned outside the pipette 200, the processing apparatus 250 can preferably be associated with several pipettes 200. In this way, for example, several pipettes 200 can be controlled with one processing apparatus 250.

The pipette 200 also comprises a second pressure sensor 255 associated with the pressure chamber 210. The second pressure sensor 255 is configured to provide a signal dependent on a pressure in the pressure chamber 210, which is referred to as the second pressure. Purely by way of example, the second pressure sensor 255 is positioned adjacent to the pressure chamber 210 and, in particular, is also positioned in the main body 202. The pipette 200 further comprises a pipetting tip support 230, in particular extending along a central axis 290. Preferably, the pipetting tip support 230 is positioned behind the main body 202 along a longitudinal direction 400 extending parallel to the central axis 290. The pipetting tip support 230 comprises a fluid channel 232, which preferably extends along the central axis 290.

The pressure chamber 210 and the fluid channel 232 are fluidly connected to each other. The fluid channel 232 extends from a first fluid channel limit 234 to a second fluid channel limit 236. An outlet valve 222 is positioned between the pressure chamber 210 and the fluid channel 232, which can be moved into an open position and into a closed position. When the outlet valve 222 is in the open position, fluid can flow from the fluid channel 232 to the pressure chamber 210 and vice versa. When the outlet valve 222 is in the closed position, fluid cannot flow from the fluid channel 232 to the pressure chamber 210 or vice versa. In this context, the relationship between the pressure chamber 210 and the pipetting tip support 230 is not necessarily a spatial or geometric relationship, but rather a fluidic relationship. That is, when the outlet valve 222 is in the open position, the fluid passes the outlet valve 222 on its way from the fluid channel 232 to the pressure chamber 210 and vice versa, or, when the outlet valve 222 is in the closed position, the fluid stops in front of the outlet valve 222 on its way from the fluid channel 232 to the pressure chamber 210 and vice versa.

Preferably, the pipette 200 comprises an ambient pressure sensor 256, which is positioned on an outer side of the main body 202 by way of example only. The ambient pressure sensor 256 is configured to provide a signal dependent on a pressure in the environment around the pipette 200, referred to as ambient pressure.

FIG. 1B shows another pipette 200 for dosing a liquid quantity. Like the pipette 200 shown in FIG. 1A, the pipette 200 shown in FIG. 1B comprises a pipetting tip support 230 with a fluid channel 232 extending from a first fluid channel limit 234 to a second fluid channel limit 236, a first pressure sensor 254, an ambient pressure sensor 256 and a processing apparatus 250. In contrast to the pipette 200 shown in FIG. 1A, in the pipette 200 shown in FIG. 1B, the main body 202 is an integral part of the pipetting tip support 230. In addition, in the pipette 200 shown in FIG. 1B, a fluid source 260 is provided that can function as a vacuum source or as a pressure source. Preferably, the fluid source 260 is controlled with the processing apparatus 250. For this purpose, a corresponding connecting line 258 is provided.

The pipette 200 shown in FIG. 1B also comprises a second pressure sensor 259 and a throttle 257. The throttle 257 is positioned between the first pressure sensor 254 and the second pressure sensor 259 and acts as a local cross-sectional constriction of the fluid channel 232. The fluid channel 232 extends from the fluid source 260 to a position at which a pipetting tip 240 is coupled to the pipetting tip support 230 (see FIG. 2).

FIG. 1C shows another pipette 200 for dosing a liquid quantity. Like the pipette 200 shown in FIG. 1A, the pipette 200 shown in FIG. 1C comprises a pipetting tip support 230, a first pressure sensor 254, an ambient pressure sensor 256 and a processing apparatus 250. Unlike the pipette 200 shown in FIG. 1A, in the pipette 200 shown in FIG. 1C, as in the pipette 200 shown in FIG. 1B, the main body 202 is an integral part of the pipetting tip support 230. In the pipette 200 shown in FIG. 1C, the fluid channel 232 extends from a third fluid channel limit 238 to a second fluid channel limit 236. The portion of the fluid channel 232 extending from the first fluid channel limit 234 to the second fluid channel limit 236 is similar to the fluid channel 232, also extending from the first fluid channel limit 234 to the second fluid channel limit 236, of the pipettes 200 shown in FIGS. 1A and 1B, respectively.

The portion of the fluid channel 232 of the pipette 200 shown in FIG. 1C extending from the third fluid channel limit 238 to the second fluid channel limit 236 is referred to as the piston channel. A piston 212 is positioned in the piston channel. The piston channel comprises the section of the fluid channel 232 in which the piston 212 is movable in the fluid channel 232. Preferably, the third fluid channel limit 238 delimiting the piston channel is provided in front of the actual end of the fluid channel 232, so that the piston 212 is completely movable in the piston channel without sliding out of the fluid channel 232. The fluid channel 232 preferably comprises two cross-sections. Here, the cross-section of the piston channel is at least larger than the average of the cross-section of the section of the fluid channel 232 extending from the first fluid channel limit 234 to the second fluid channel limit 236.

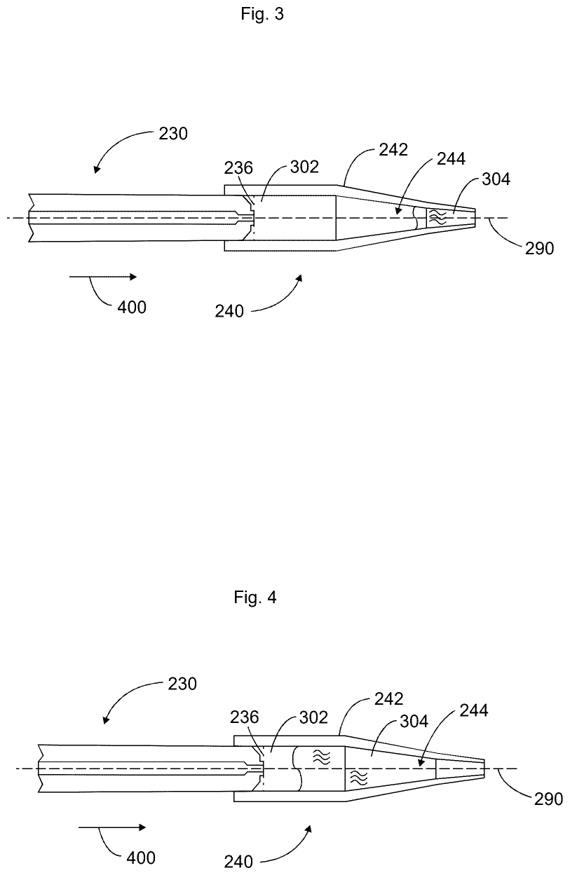

Preferably, the piston 212 is sized such that it is movable in the piston channel along the central axis 290, but at least not completely in the section of the fluid channel 232 extending from the first fluid channel limit 234 to the second fluid channel limit 236. Preferably, a sealing element, in particular a flexible sealing element, is provided between the outer wall of the piston 212 facing the inner wall of the fluid channel 232. In this way, it is made possible that working fluid 302 taken up in the fluid channel 232 cannot leak out of the fluid channel 232 along the piston 212. In addition, it is made possible in such a way that, by moving the piston 212 in the direction of the position at which a pipetting tip 240 is coupled to the pipetting tip support 230 (cf. FIG. 2), pressure can be built up in the fluid channel 232 so that a sample fluid 304 received in the pipetting tip 240 can be discharged from the pipette 200 (cf. FIGS. 3 and 4).

The pipette 200 shown in FIG. 1C comprises a position sensor 252 positioned near the piston 212. Preferably, the position sensor 252 extends along the central axis 290 so that the piston 212 remains close to the position sensor 252 over a large part of its possible path in the fluid channel 232. By means of the position sensor 252, a path traveled by the piston 212 in the fluid channel 232 and/or a position of the piston 212 in the fluid channel 232 can be determined.

Insofar as identical components of the pipettes 200 are shown in FIGS. 1A to 1C, what has been explained above by way of example only with respect to one pipette 200 applies in the same way to the other pipettes 200.

FIG. 2 shows the pipette 200 shown in FIG. 1 with a pipetting tip 240 coupled to the pipetting tip support 230. The pipetting tip 240 comprises an outer shell 242 surrounding an interior area 244. Preferably, the ambient pressure is determined in an environment surrounding the pipetting tip 240. The pipetting tip 240 is coupled to the pipetting tip support 230 such that the inner volume of the fluid channel 232 is limited with respect to the inner volume of the pipetting tip 240 by the second fluid channel limit 236.

The processing apparatus 250 is preferably configured to retrieve signals from the first pressure sensor 254, the second pressure sensor 255, 259 or the position sensor 252 and the ambient pressure sensor 256 and to control the working valve apparatus 220 and the outlet valve 222. For this purpose, the processing apparatus 250 is preferably connected via a connecting line 258 in each case to the first pressure sensor 254, to the second pressure sensor 255, 259 or to the position sensor 252, to the ambient pressure sensor 256, to the working valve apparatus 220 and to the outlet valve 222. Preferably, the connecting lines 258 are each configured to establish an electrical connection between the respective components connected to one of the connecting lines 258. Preferably, the processing apparatus 250 is configured to generate, with a sensor signal of the first pressure sensor 254 and a sensor signal of the second pressure sensor 255, 259 or position sensor 252 to determine at least one characteristic value from the group: change of the amount of the working fluid 302 in the fluid channel 232, pipetting tip pressure in the pipetting tip 240, volume flow of the sample fluid 304 which flows into the pipetting tip 240, viscosity of the sample fluid 304 which flows into the pipetting tip 240, volume of the sample fluid 304 held in the pipetting tip 240.

Preferably, the pipetting tip 240 is fitted onto the pipetting tip support 230 such that the interior area 244 acts as an extension of the fluid channel 232 beyond the second fluid channel limit 236 along the central axis 290 and in the longitudinal direction 400. If there is a lower pressure in the pressure chamber 210 than in the fluid channel 232, i.e., that the second pressure is lower than the first pressure and the outlet valve 222 is in the open position, a suction effect results on a fluid taken up in the fluid channel 232, which leads to this fluid being moved in the direction of the pressure chamber 210, i.e. in the configuration shown in FIGS. 1 and 2 against the longitudinal direction 400. This suction effect also affects a working fluid 302 taken up in the pipetting tip 240 (cf. FIGS. 3 and 4).

If the pipetting tip 240 is immersed in a sample fluid 304 in this state, this sample fluid 304 is sucked into the pipetting tip 240.

The foregoing description with respect to the pipette 200 shown in FIGS. 1A and 2, in particular with respect to receiving the sample fluid 304 in the pipette 200, applies in the same way to the pipettes 200 shown in FIGS. 1B and 1C, taking into account the structural and functional differences.

FIG. 3 shows a detail of the pipette 200 shown in FIG. 2, in which the pipetting tip 240 and a front part of the pipetting tip support 230 in the longitudinal direction 400 are shown. In the configuration shown in FIG. 3, some sample fluid 304 has already been sucked into the pipetting tip 240; in the configuration shown in FIG. 4, the suction process has been further progressed. Accordingly, in the configuration shown in FIG. 4, there is more sample fluid 304 and thus less working fluid 302 in the pipetting tip 240 than in the configuration shown in FIG. 3. The configurations illustrated in FIGS. 3 and 4 are equally transferable to the pipettes 200 illustrated in FIGS. 1B and 1C.

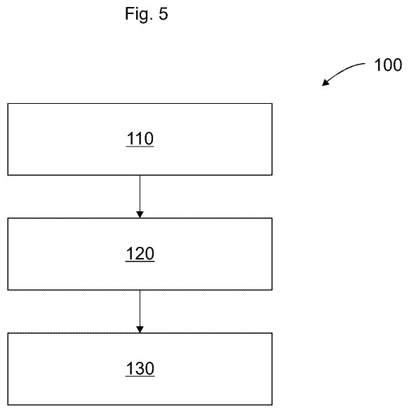

The pipetting tip 240 shown in FIGS. 2 to 4 is preferably disposed of after a small number of uses and is configured in particular as a disposable product. In order to save costs, no sensors are provided in a pipetting tip 240 configured in this way. In order to nevertheless be able to reliably generate characteristic values with reference to the pipetting tip 240, a method 100 shown in FIG. 5 is carried out for dosing a liquid quantity.

The method 100 comprises the following steps. In a first step 110, the working fluid 302 is moved in the fluid channel 232 of the pipetting tip support 230, which fluid channel extends at least from the first fluid channel limit 234 to the second fluid channel limit 236. In a second step 120, a fluid movement taking place over the first fluid channel limit 234 and/or the second fluid channel limit 236 is detected with the sensor arrangement associated with the fluid channel 232, which sensor arrangement comprises the first pressure sensor 254 and a further sensor from the group: second pressure sensor 255; 259, position sensor 252. In a third step 130, at least one characteristic value from the group: change of the amount of the working fluid 302 in the fluid channel 232, pipetting tip pressure in a pipetting tip 240 coupled to the pipetting tip support 230, volume flow of a sample fluid 304 flowing into a pipetting tip 240 coupled to the pipetting tip support 230, viscosity of a sample fluid 304 flowing into a pipetting tip 240 coupled to the pipetting tip support 230, volume of a sample fluid 304 held in a pipetting tip 240 coupled to the pipetting tip support 230 is determined with a sensor signal of the first pressure sensor 254 and a sensor signal of the further sensor.

What is claimed is:

1. A method for dosing a liquid quantity, comprising the steps of: moving a working fluid in a fluid channel of a pipetting tip support, which fluid channel extends at least from a first fluid channel limit to a second fluid channel limit, detecting a fluid movement taking place over the first fluid channel limit and/or the second fluid channel limit with a sensor arrangement associated with the fluid channel, which sensor arrangement comprises a first pressure sensor and a further sensor from the group: second pressure sensor, position sensor, wherein at least one characteristic value from the group: change of the amount of the working fluid in the fluid channel, pipetting tip pressure in a pipetting tip coupled to the pipetting tip support, volume flow of a sample fluid flowing into a pipetting tip coupled to the pipetting tip support, viscosity of a sample fluid flowing into a pipetting tip coupled to the pipetting tip support, volume of a sample fluid held in a pipetting tip coupled to the pipetting tip support is determined with a sensor signal of the first pressure sensor and a sensor signal of the further sensor.

2. The method according to claim 1, wherein the further sensor is configured as a second pressure sensor, which is associated with a pressure chamber fluidically connected to the fluid channel, wherein a second pressure in the pressure chamber is determined with the second pressure sensor, wherein the working fluid is moved in the fluid channel by opening an outlet valve positioned between the pressure chamber and the fluid channel in order to at least partially equalize a pressure difference between the pressure chamber and the fluid channel.

3. The method according to claim 1, wherein the further sensor is configured as a second pressure sensor, wherein the sensor arrangement is used to determine a flow rate through an inlet valve positioned on the fluid channel, wherein the working fluid is moved in the fluid channel by opening the inlet valve in order to at least partially equalize a pressure difference between a fluid source fluidically connected to the fluid channel.

4. The method according to claim 1, wherein the further sensor is configured as a position sensor, with which a travel path of a piston positioned in the fluid channel is determined, wherein the working fluid is moved in the fluid channel by moving the piston along the fluid channel.

5. The method according to claim 1, wherein a mass flow rate of the working fluid across the second fluid channel limit into a pipetting tip is determined as a difference between a mass flow rate of the working fluid across the first fluid channel limit into the fluid channel and a change of the amount of the working fluid in the fluid channel.

6. The method according to claim 5, wherein the change of the amount of the working fluid in the fluid channel is determined as a product of the derivative of the first pressure after time and a fluid channel volume of the fluid channel.

7. The method according to claim 2, wherein the mass flow rate of the working fluid across the first fluid channel limit into the fluid channel is determined as a product of the derivative of the second pressure after time and a pressure chamber volume of the pressure chamber.

8. The method according to claim 3, wherein the mass flow rate of the working fluid across the first fluid channel limit into the fluid channel is determined on the basis of the first pressure and a second pressure determined with the second pressure sensor according to ISO 6358-1:2013(E).

9. The method according to claim 4, wherein the mass flow rate of the working fluid across the first fluid channel limit into the fluid channel is determined as a derivative of the product of the first pressure and a piston channel volume of the fluid channel extending from the first fluid channel limit to the third fluid channel limit after time.

10. The method according to claim 1, wherein a pipetting tip pressure in a pipetting tip coupled to the pipetting tip support is determined as the difference between the first pressure and a first differential pressure.

11. The method according to claim 10, wherein the first differential pressure is determined as the product of a flow resistance counteracting the working fluid and the mass flow rate of the working fluid across the second fluid channel limit into a pipetting tip.

12. The method according to claim 10, wherein the first differential pressure is determined from flow characteristics of the fluid channel and the mass flow of the working fluid across the second fluid channel limit into the pipetting tip according to ISO 6358-1:2013(E).

13. The method according to claim 10, wherein an ambient pressure in an environment is determined by means of an ambient pressure sensor associated with the environment, wherein the environment surrounds a pipetting tip coupled to the pipetting tip support, wherein a second differential pressure is determined as the difference between the pipetting tip pressure and the ambient pressure.

14. The method according to claim 13, wherein a flow resistance of the sample fluid is determined as the quotient of the second differential pressure as the divisor and a derivative of a sample volume taken up in a pipetting tip coupled to the pipetting tip support after time as the divisor.

15. The method according to claim 14, wherein the sample volume is determined as the difference between a pipetting tip volume of the pipetting tip and a working fluid volume present in the pipetting tip.

16. The method according to claim 15, wherein the working fluid volume present in the pipetting tip is determined by means of a working fluid amount contained in the pipetting tip, wherein the working fluid amount contained in the pipetting tip is determined as the difference between a working fluid amount initially contained in the pipetting tip and a working fluid amount transferred from the pipetting tip into the fluid channel via the second fluid channel limit.

17. The method according to claim 16, wherein the amount of working fluid initially contained in the pipetting tip is determined as the product of an initial pipetting tip pressure and the pipetting tip volume.

18. A pipette for dosing a liquid quantity, comprising a pipetting tip support, a fluid channel associated to the pipetting tip support, a sensor arrangement which is associated to the fluid channel and comprises a first pressure sensor and a further sensor from the group: second pressure sensor, position sensor, and a processing apparatus which is set up to retrieve signals from the sensor arrangement, wherein the fluid channel extends from a first fluid channel limit to a second fluid channel limit, wherein the processing apparatus is configured to determine at least one characteristic value from the group: change of the amount of the working fluid in the fluid channel, pipetting tip pressure in a pipetting tip coupled to the pipetting tip support, volume flow of a sample fluid flowing into a pipetting tip coupled to the pipetting tip support, viscosity of a sample fluid flowing into a pipetting tip coupled to the pipetting tip support, volume of a sample fluid held in a pipetting tip coupled to the pipetting tip support with a sensor signal of the first pressure sensor and a sensor signal of the further sensor.

19. The pipette according to claim 18, wherein a pressure chamber fluidically connected to the fluid channel is provided, the further sensor being configured as a second pressure sensor and being associated with the pressure chamber, wherein a working valve apparatus associated with the pressure chamber and an outlet valve positioned between the pressure chamber and the fluid channel are provided.

20. The pipette according to claim 18, wherein the second sensor is configured as a second pressure sensor, wherein a throttle is positioned between the first pressure sensor and the second pressure sensor, wherein an inlet valve is positioned on the fluid channel, wherein the sensor arrangement is configured to determine a flow rate through the inlet valve.

21. The pipette according to claim 18, wherein a piston is positioned in the fluid channel, the further sensor being configured as a position sensor, with which a travel path of the piston along the fluid channel can be determined.
